(19) United States
(12) Patent Application Publication
(10) Pub. No.: US 2013/0221913 A1
(43) Pub. Date: Aug. 29, 2013

(54) WIRELESS CHARGING DEVICE, TERMINAL, AND METHOD FOR WIRELESS CHARGING

(71) Applicant: Pantech Co., Ltd., (US)

(72) Inventor: Jae-Ki KIM, Gimpo-si (KR)

(73) Assignee: Pantech Co., Ltd., Seoul (KR)

(21) Appl. No.: 13/776,139

(22) Filed: Feb. 25, 2013

(30) Foreign Application Priority Data
Feb. 29, 2012 (KR) 10-2012-0021399

(51) Int. Cl. H02J 7/00

(52) U.S. Cl. CPC H02J 7/0042; H02J 7/0052
USPC 320/108; 320/137

(57) ABSTRACT

A method for operating a wireless charging device includes detecting a chargeable terminal, detecting a valid block coil according to information transmitted from the chargeable terminal, switching on the valid block coil, and controlling a current supply to the valid block coil. A terminal includes a receiving coil configured to induce a current in response to receipt of wireless power, an induced voltage detection unit to measure an induced voltage generated by the induced current, and to generate induced voltage information, and a communication unit to transmit the induced voltage information to a wireless charging device.

### CROSS-REFERENCE TO RELATED APPLICATION

This application claims priority from and the benefit under 35 U.S.C. §119(a) of Korean Patent Application No. 10-2012-0021399, filed on Feb. 29, 2012, which is incorporated herein by reference for all purposes as if fully set forth herein.

### BACKGROUND

1. Field

The following description relates to a non-contact charging device, terminal, and method for non-contact charging.

2. Discussion of the Background

Various Information Technology (IT) devices, such as mobile communication terminals (for example, smartphones or Personal Digital Assistants (PDAs)), notebook is computers, etc., have emerged and become widespread. Such devices include portable devices and are equipped with batteries for power supply. Conventionally, a device equipped with a battery may be charged by detaching the battery from the device and inserting the battery into a battery charger or connecting the device with a battery charger while keeping the battery in the device. Non-contact charging devices, which wirelessly charge the batteries of mobile devices by using an electromagnetic induction-based wireless power transmission technique, are gaining demand from electronic device consumers.

Generally, a primary coil is installed in a non-contact charging device, and a secondary coil is installed in a device having a battery. The efficiency of the non-contact charging device depends on the degree of matching between the primary coil and the secondary coil.

FIG. 1 illustrates various examples of degrees of matching between a primary coil and a secondary coil.

Referring to FIG. 1(a), if a primary coil and a secondary coil are misaligned with each other, the secondary coil may receive only part of the magnetic flux variation transmitted by the primary coil. Accordingly, part of the power transmitted by the primary coil may not be conveyed to the secondary coil, and the efficiency of charging may decrease.

Referring to FIG. 1(b), if the area of a primary coil is larger than the area of a secondary coil, the secondary coil may receive only part of the magnetic flux variation transmitted by the primary coil. Accordingly, part of the power transmitted by the primary coil may not be conveyed to the secondary coil, and the efficiency of charging may decrease.

Referring to FIG. 1(c), if the area of a primary coil is smaller than the area of a secondary coil, the secondary coil may receive all the magnetic flux variation transmitted by the is primary coil, but the received magnetic flux variation may be insufficient due to the small area of the primary coil. Therefore, the efficiency of charging may decrease, and the amount of time for charging a terminal having the secondary coil may increase.

Referring to FIG. 1(d), if a primary coil and a secondary coil are properly aligned with each other and have the same area, the secondary may receive all the magnetic flux variation transmitted from the primary coil, and an optimum charging efficiency may be achieved since the power transmitted from the primary coil is efficiently conveyed to the secondary coil while utilizing the full capacity of the secondary coil.

As illustrated in FIG. 1, the efficiency of charging may be increased when the primary coil and the secondary coil have the same area and are properly aligned, for example, centers of two coils coincide with each other. To meet these requirements, a non-contact charging device may need to be customized for terminals having different secondary coils.

FIG. 2 illustrates an example of a non-contact charging device and a non-contact chargeable terminal according to related art.

Referring to FIG. 2, a terminal 11 may be configured to match a non-contact charging device 10 having a groove formed in the cradle of the non-contact charging device 10. The non-contact charging device 10 includes a primary coil having a capacity to supply power to a secondary coil installed in the terminal 11. The non-contact charging device 10 may have a structure for fixing the location of the particular terminal 11 such that the secondary coil may match the primary coil. However, the non-contact charging device 10 may not charge other terminals having different secondary coils efficiently. In addition, even the terminal 11 may not be properly charged unless the charged terminal 11 is properly located on the non-contact charging device 10.

Further, as the types of IT devices used by consumers diversify, there is a demand for universal non-contact charging devices capable of charging different types of IT devices. However, since various terminals have different sizes and various secondary coil capacities, it may be difficult to design a non-contact charging device that is fit and efficient for all types of terminals.

Therefore, there is an increased demand for a non-contact charging device capable of offering maximum charging efficiency regardless of the size of a terminal and the capacity of the secondary coil of the terminal.

Although a method to adjust the degree of matching between a non-contact charging device and a chargeable terminal with the use of a driving motor has been suggested, the method that moves a coil with the use of a driving motor may increase the thickness of a cradle of a non-contact charging device due to the presence of the driving motor and the position controller of the driving motor. Also, in a method of searching for a matching primary coil for a secondary coil with the use of an ambient light sensor, a proximity sensor, etc., the primary coil may be placed at a wrong place so that charging may fail. Also, the efficiency of charging may decrease, and the manufacturing cost of a non-contact charging device may increase due to the use of the sensors and the driving motor.

### SUMMARY

Exemplary embodiments of the present invention provide a non-contact charging device, terminal, and method for non-contact charging. The matching between a primary coil and a secondary coil may be adjusted by switching primary coil blocks to provide an increased charging efficiency.

According to aspects, coil matching may be adjusted without the use of sensors or driving motors.

Additional features of the invention will be set forth in the description which follows, and in part will be apparent from the description, or may be learned by practice of the invention.

Exemplary embodiments of the present invention provide a wireless charging device, including a first block coil to transfer wireless power; a first power source to provide the first block coil with a current for generating a first wireless power; a first switch to connect the first power source with the first block coil; and a controller to determine whether the first block coil is a valid block coil for a first chargeable terminal, and to control the first switch to connect the first power source with the first block coil if the first block coil is determined as a valid block coil for the first chargeable terminal.

Exemplary embodiments of the present invention provide a method for operating a wireless charging device, including detecting a chargeable terminal; detecting a valid block coil according to information transmitted from the chargeable terminal; switching on the valid block coil; and controlling a current supply to the valid block coil.

Exemplary embodiments of the present invention provide a terminal, including a receiving coil configured to induce a current in response to receipt of wireless power; an induced voltage detection unit to measure an induced voltage value generated by the induced current, and to generate induced voltage information; and a communication unit to transmit the induced voltage information to a wireless charging device.

Exemplary embodiments of the present invention provide a wireless charging device, including: one or more block coils; a power source to supply a current to a valid block is coil for a chargeable terminal, the valid block coil being selected from among the one or more block coils; and a controller to detect the valid block coil for the chargeable terminal based on an induced voltage value, and to control a current flow into the valid block coil.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates various examples of matching between a primary coil and a secondary coil.

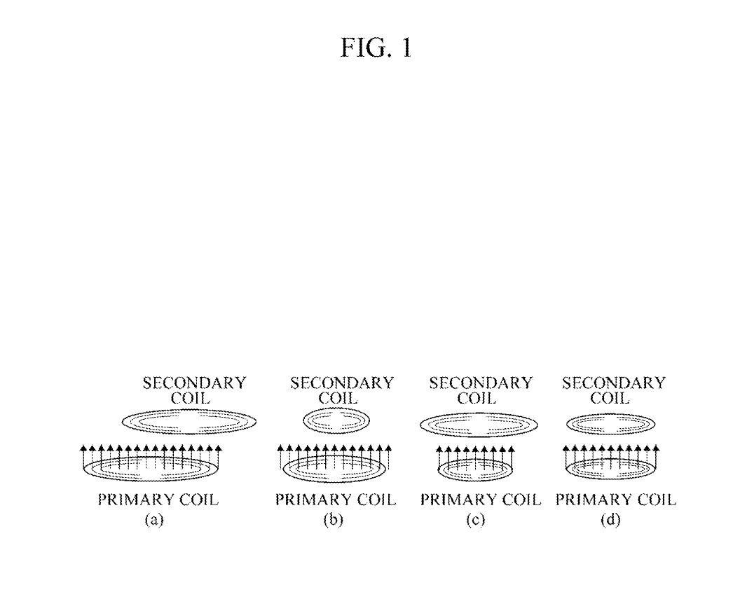

FIG. 2 is a diagram illustrating an example of a related-art non-contact charging device and a related-art charged terminal.

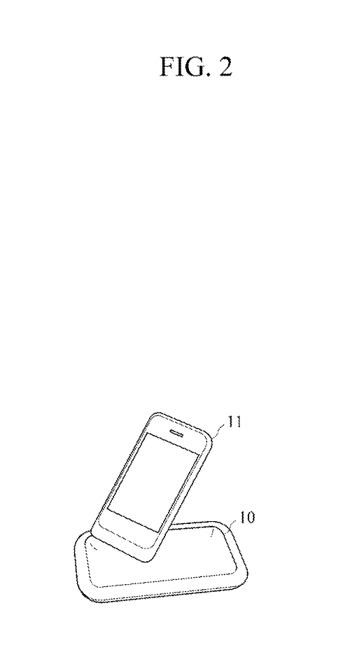

FIG. 3 is a diagram illustrating a non-contact charging system according to an exemplary embodiment of the present invention.

FIG. 4 is a diagram illustrating an example of the arrangement of a plurality of block coils in a non-contact charging device according to an exemplary embodiment of the present invention.

FIG. 5 is a diagram illustrating an example of a switching structure for a plurality is of block coils in a non-contact charging device according to an exemplary embodiment of the present invention.

FIG. 6A is a diagram illustrating an example of a chargeable terminal placed over a non-contact charging device according to an exemplary embodiment of the present invention.

FIG. 6B is a graph illustrating an example of voltages induced in the chargeable terminal illustrated in FIG. 6A according to an exemplary embodiment of the present invention.

FIG. 7 is a block diagram illustrating an example of an induced voltage detection unit of a chargeable terminal according to an exemplary embodiment of the present invention.

FIG. 8 is a diagram illustrating an example of a chargeable terminal placed over a non-contact charging device according to an exemplary embodiment of the present invention.

FIG. 9A is a flowchart illustrating a non-contact charging method according to an exemplary embodiment of the present invention.

FIG. 9B is a flowchart illustrating searching method for detecting valid block coils according to an exemplary embodiment of the present invention.

FIG. 10A is a diagram illustrating an example of multiple chargeable terminals placed over a non-contact charging device according to an exemplary embodiment of the present invention.

FIG. 10B is a graph illustrating an example of voltages induced in the multiple chargeable terminals illustrated in FIG. 10A according to an exemplary embodiment of the present invention.

FIG. 11 is a flowchart illustrating a non-contact charging method using block coils according to an exemplary embodiment of the present invention.

FIG. 12 is a diagram illustrating an example of a switching structure for a is plurality of block coils in a non-contact charging device according to another exemplary embodiment of the present invention.

FIG. 13 is a diagram illustrating an example of a switching structure for a plurality of block coils in a non-contact charging device according to another exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed is below could be termed a second element, component, region, layer or section without departing from the teachings of the present invention.

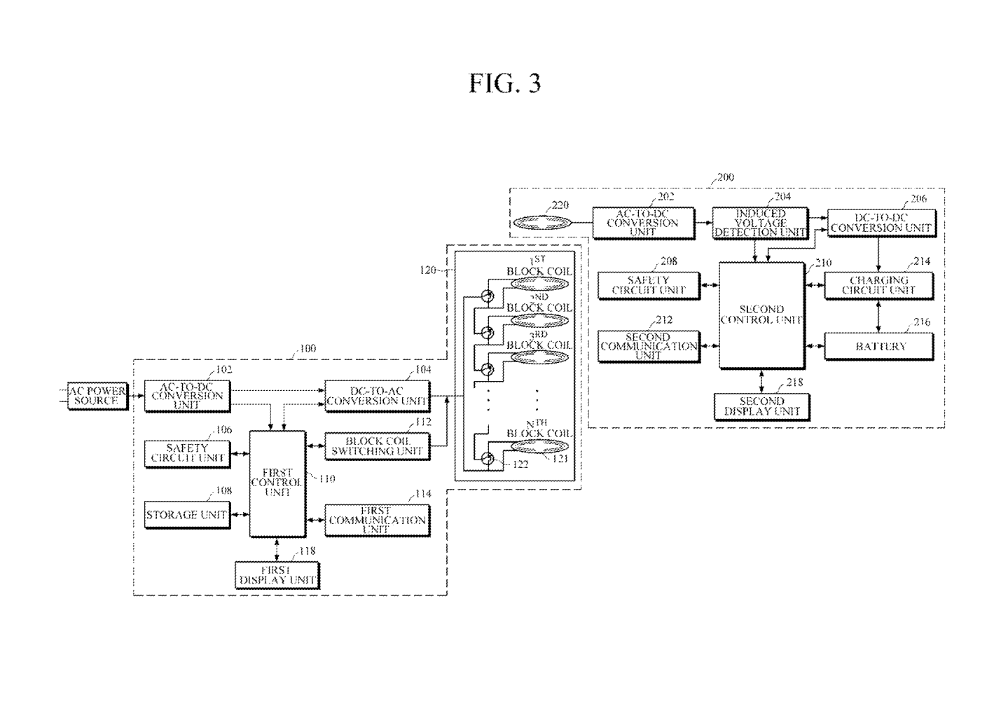

FIG. 3 illustrates a non-contact charging system according to an exemplary embodiment of the present invention.

Referring to FIG. 3, a non-contact charging device 100, which supplies power to a chargeable terminal 200 and charges the chargeable terminal 200 by using an electromagnetic induction charging method, includes an alternating current (AC)-to-direct current (DC) conversion unit 102, a DC-to-AC conversion unit 104, a safety circuit unit 106, a storage unit 108, a first control unit 110, a block coil switching unit 112, a first communication unit 114, a first display unit 118, and a primary coil 120. Throughout the specification, the term “non-contact charging” may refer to a charging an electronic device without a wired connection, and may be referred to as “wireless charging”. The non-contact charging may include an inductive charging in which energy is transferred through inductive coupling. For example, if a non-contact charging device is not connected with a chargeable terminal via a wired connection and provides a wireless charging power to the chargeable terminal, the non-contact charging device and the chargeable terminal to be charged by the non-contact charging device may be contacted with each other while performing a non-contact charging procedure.

The chargeable terminal 200 includes an AC-to-DC conversion unit 202, an induced voltage detection unit 204, a DC-to-DC conversion unit 206, a safety circuit unit 208, a second control unit 210, a second communication unit 212, a charging circuit unit 214, a battery 216, a second display unit 218, and a secondary coil 220.

The AC-to-DC conversion unit 102 of the non-contact charging device 100 may receive AC power from an external source (not shown), and output a DC voltage to the DC-to-AC conversion unit 104. The AC-to-DC conversion unit 102 may supply the DC voltage to the first control unit 110 so that various circuits may operate and be controlled by the first control unit 110.

The DC-to-AC conversion unit 104 may receive DC power from the AC-to-DC conversion unit 102, and output an AC voltage or AC current to the primary coil 120. If an AC voltage or AC current is applied to the primary coil 120, the magnetic flux of the primary coil 120 varies, and the variation in the magnetic flux of the primary coil 120 generates an induced electromotive force (induced current or voltage) in the secondary coil 220. The electromagnetic induction technique is well-known to one of ordinary skill in the art, and thus a detailed description thereof will be omitted. The secondary coil 220 may be referred to as a receiving coil configured to receive wireless power from a primary coil, e.g., the primary coil 120.

The safety circuit unit 106 may monitor the non-contact charging device 100 to detect abnormal operations or conditions, such as, for example, an abnormally high temperature, an abnormal voltage, and an abnormal current. In response to a determination that the non-contact charging device 100 is in an abnormal state or condition, the safety circuit unit 106 may transmit information relating to the abnormal state of the non-contact charging device 100 to the first control unit 110 to stop a charging operation to prevent the risk of damages that may be caused in a case in which the temperature in the non-contact charging device 100 is too high or an excessive current or voltage is generated in the non-contact charging device 100. For example, if the temperature, the current, or the voltage is greater than a safety value, it may be determined as an abnormal state by the safety circuit unit 106.

The storage unit 108 may store data for the non-contact charging device 100 to perform various control operations. For example, the storage unit 108 may store terminal information. The terminal information may be used to determine whether the chargeable terminal 200 when it is placed in a cradle of the non-contact charging device (not illustrated), is a target terminal to be charged. To prevent the cradle from being overheated due to an improper metallic material placed thereon and to improve the safety and efficiency of circuitry, power may be supplied only to a verified terminal rather than to any terminal equipped with a battery. The terminal information may include authentication information of the chargeable terminal 200.

The block coil switching unit 112 may turn on or off one or more switches 122, which are connected to a plurality of block coils included in the primary coil 120, under the control of the first control unit 110 to increase the charging efficiency.

The first communication unit 114 may transmit data to or receive data from the second communication unit 212. For example, the first communication 114 and the second communication unit 212 may communicate with each other by using a wireless communication method, such as an electromagnetic induction communication method or a non-contact near field communication method. The first communication 114 and the second communication unit 212 may use various wireless communication methods, other than those set forth herein, to communicate with each other. The first communication unit 114 may receive various operation information relating to the chargeable terminal 200, such as a charged state, a safety state, detection information, and authentication information, from the second communication unit 212. The first communication unit 114 may also receive valid block coil information from the second communication unit 212.

The first display unit 118 may display various operating state information relating to the non-contact charging device 100, such as a charged state of the chargeable terminal 200 or abnormal states in the operating state of the non-contact charging device 100. For example, the is first display unit 118 may be implemented as a light-emitting diode (LED), a liquid-crystal display (LCD), an organic Electro Luminescence (EL) display, and the like, for example. The first display unit 118 may display various colors of light or display information in various colors according to the state of connection of the non-contact charging device 100 to an AC power source and the power supply state of the non-contact charging device 100. Further, the first display unit 118 may display information related to a valid block coil. The information related to valid block coil may include location information of valid block coils, identification information of valid block coils, index numbers of the valid block coils, and the like.

The first control unit 110 may receive various information from other units of the non-contact charging device 100 and perform a general control operation in connection with a charging operation performed by the non-contact charging device 100.

The magnetic flux of the primary coil 120 may vary due to an induced current output by the DC-to-AC conversion unit 104. For example, the primary coil 120 may include a plurality of block coils 121 and a plurality of switches 122 connected to the block coils 121, respectively, to improve the charging efficiency for various types of wirelessly chargeable terminals.

The AC-to-DC conversion unit 202 may convert an AC induced voltage generated in the secondary coil 220 by electromagnetic induction into a DC voltage. The DC Voltage may be transmitted to the second control unit 210 and/or the DC-to-DC conversion unit 206.

The induced voltage detection unit 204 may detect an output voltage of the AC-to-DC conversion unit 202. The induced voltage detection unit 204 may detect a DC induced voltage generated by the secondary coil 220. For example, the induced voltage detection unit 204 may detect valid block coils from among the block coils 121 of the primary coil 120 based on a variation in the detected DC induced voltage. The term “valid block coil,” as used herein, indicates one or more block coils among the block coils 121 that coincide with the secondary coil 220 of the chargeable terminal 200 determined based on the location and size of the secondary coil 220 of the chargeable terminal 200.

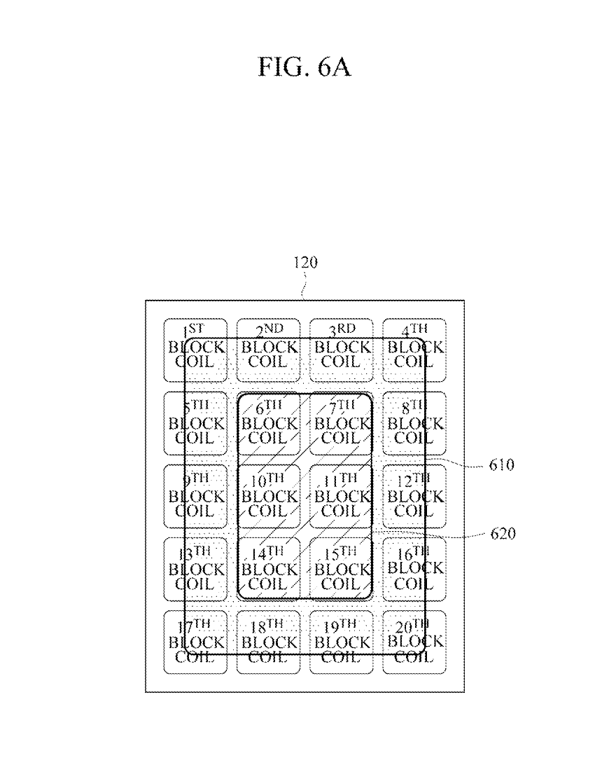

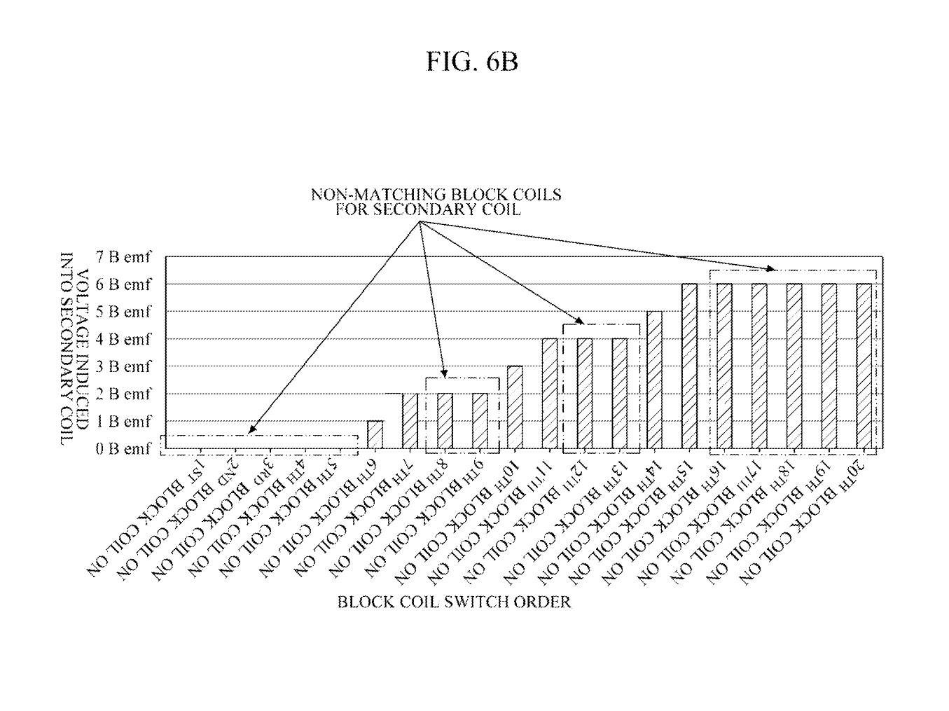

The induced voltage detection unit 204 may generate induced voltage information based on the detected induced voltage, and transmit the induced voltage information to the non-contact charging device 100 via the second communication unit 212. The induced voltage information may include voltage difference between induced voltages in response to a switching on a block coil in the non-contact charging device 100. The block coil may be determined as a valid block coil if the voltage difference in the induced voltage detection unit 204 is greater than a reference value. For example, the reference value may be zero. According to this reference value configuration, if a valid block coil is switched on, the valid block coil induces a current in the secondary coil 220 of the chargeable terminal 200 and the induced current causes the voltage difference in the induced voltage detection unit 204. On the other hand, if a non-valid block coil is switched on, the non-valid block coil does not induce a current in the secondary coil 220 of the chargeable terminal 200 and the voltage difference does not occur in the induced voltage detection unit 204. The induced voltage information may include the induced voltage value and/or the voltage difference. For example, if a first block coil is a valid block coil and a second block coil, which is the next block coil of the first block coil, is not a valid block coil, the first block coil induces an induced voltage in the secondary coil 220 of the chargeable terminal 200 but the second block coil does not induce an induce voltage in the secondary block coil 220 of the chargeable terminal 220. According to aspects of the invention, if the induced voltage value is associated with the first block coil is ‘A’, the induced voltage value associated with the second block coil is also ‘A’ because the second block coil does not induce an induced voltage (induced voltage is zero) and the induced voltage values are cumulative (See e.g., FIG. 6B). The difference between the two induced voltage values is zero (A−A=0), which indicates the second block coil does not generate an induced voltage and is not a valid block coil.

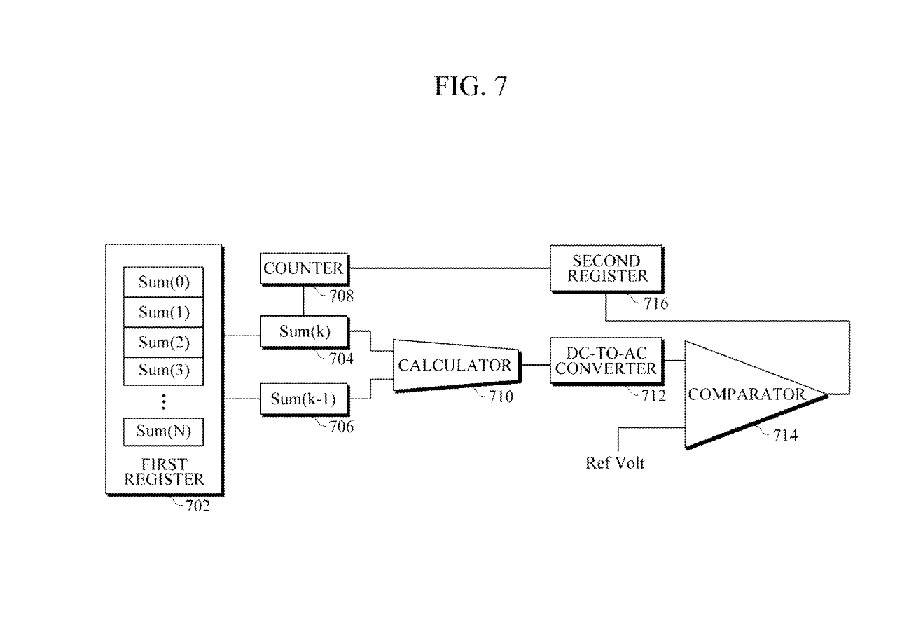

In another example, the induced voltage detection unit 204 may transmit the induced voltage value as the induced voltage information to the non-contact charging device 100 via the second communication unit 212. The non-contact charging device 100 may calculate the voltage difference by comparing induced voltages (induced voltage values) based on the induced voltage information received from the second communication unit 212. For example, the non-contact charging device 100 may include a valid block coil determining unit (not shown). In this scheme, the non-contact charging device 100 may receive induced voltage information from the second communication unit 212. The non-contact charging device 100 may retrieve an induced voltage value associated with a block coil of the primary coil 120 from the induced voltage information, and may store the retrieved induced voltage value in a register. The valid block coil determining unit may have a structure illustrated in FIG. 7, but aspects are not limited thereto. The calculation of the voltage difference will be described in detail later with reference to FIG. 6B and FIG. 7.

The DC-to-DC conversion unit 206 may receive a DC voltage from the AC-to-DC conversion unit 202, and convert the received DC voltage into a DC voltage appropriate for charging the battery 216.

The charging circuit unit 214 may control a charging operation for the battery 216 in accordance with a command issued by the second control unit 210.

The safety circuit unit 208 may perform the similar operation performed by the safety circuit unit 106 of the non-contact charging device 100. The safety circuit unit 208 may detect abnormal operations or conditions, such as an abnormally high temperature, an excessive voltage, or an excessive current, etc., from the chargeable terminal 200 and transmit the detection result to the second control unit 210.

The second communication unit 212 may transmit information to and receive information from the first communication unit 118.

The second display unit 218 may display various operating state information relating to the chargeable terminal 200, such as a charged state. The second display unit 218 may be implemented as the main display of the chargeable terminal 200 or may be provided separately from the main display of the chargeable terminal 200 to display information relating to the charging state of the chargeable terminal 200. The second display unit 218, like the first display unit 118, may be implemented in various display devices, such as an LED, an LCD, an organic EL device, etc.

The second control unit 210 may receive various information from other units of the chargeable terminal 200, and perform a general control operation in connection with the charging of the chargeable terminal 200. For example, the second control unit 210 may receive information relating to valid block coils from the induced voltage detection unit 204, and may transmit the received information to the non-contact charging device 100. Accordingly, the non-contact charging device 100 may supply power only to the valid block coils, which coincide with the secondary coil 220 determined based on the location and size of the chargeable terminal 200, and the charging efficiency may be increased and the charging may be customized to the chargeable terminal 200.

To improve charging efficiency, the primary coil 120 and the secondary coil 220 may need to properly match each other in terms of the location and the size of coils. In the non-contact charging device 100, the primary coil 120 may be divided into a plurality of block coils so that the block coils may be variably turned on independently in accordance with the location and size of the secondary coil 220.

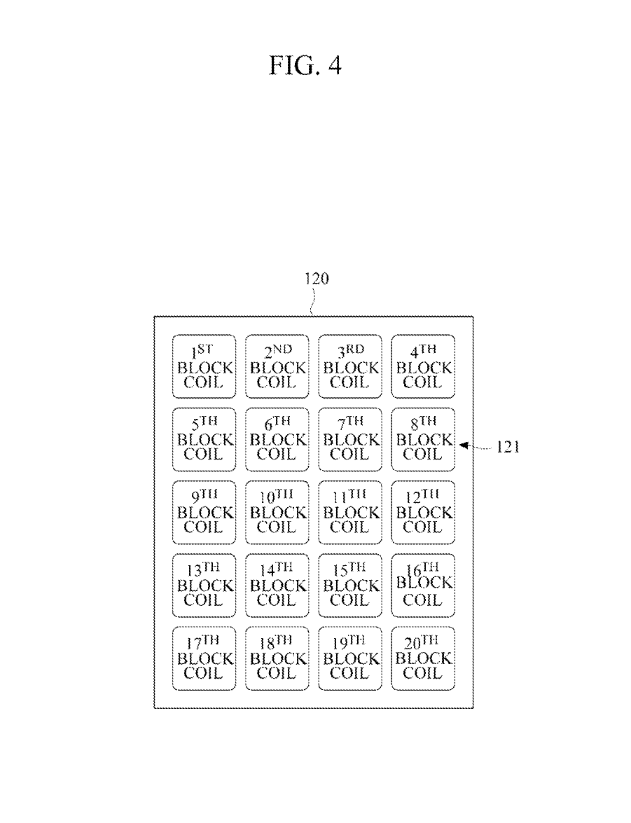

FIG. 4 is a diagram illustrating an example of the arrangement of the block coils 121 of the primary coil 120, according to an exemplary embodiment of the present invention.

Referring to FIG. 4, a charging space to accommodate the chargeable terminal 200 is divided into a plurality of blocks, and the block coils 121 of the primary coil 120 are arranged in the blocks, respectively. In the example illustrated in FIG. 4, twenty block coils are provided; however, the number of block coils may be varied. To increase the degree of matching between the primary coil 120 and the secondary coil 220, the size of each of the block coils 121 may be reduced, and the number of block coils 121 may be increased. If the number of block coils 121 increases and the detection of valid block coils are performed sequentially, the amount of time for the detection process may also increase. Thus, the number of block coils 121 and the size of each block coil may be determined based on the degree of matching between the primary coil 120 and the secondary coil 220 and the amount of time for detecting valid block coils.

Each of the block coils 121 may have an index such that the order of the index numbers reflects the order to drive the block coils 121 to detect valid block coils from among the block coils 121. The block coils 121 may have indexes ranging from 1 to 20 according to an indexing direction, such as a left-to-right direction, a top-to-bottom direction, etc., as illustrated in FIG. 4.

An induced current may be applied to the block coils 121 in the order of the index is numbers respectively assigned to the block coils 121, or may be applied only to one or more valid block coils 121 selected from among the block coils 121. To control the current flow of an induced current into all the block coils 121 or only into the valid block coils 121, one or more switches 122 may be provided so that power may be selectively supplied to or cut off from each of the block coils 121.

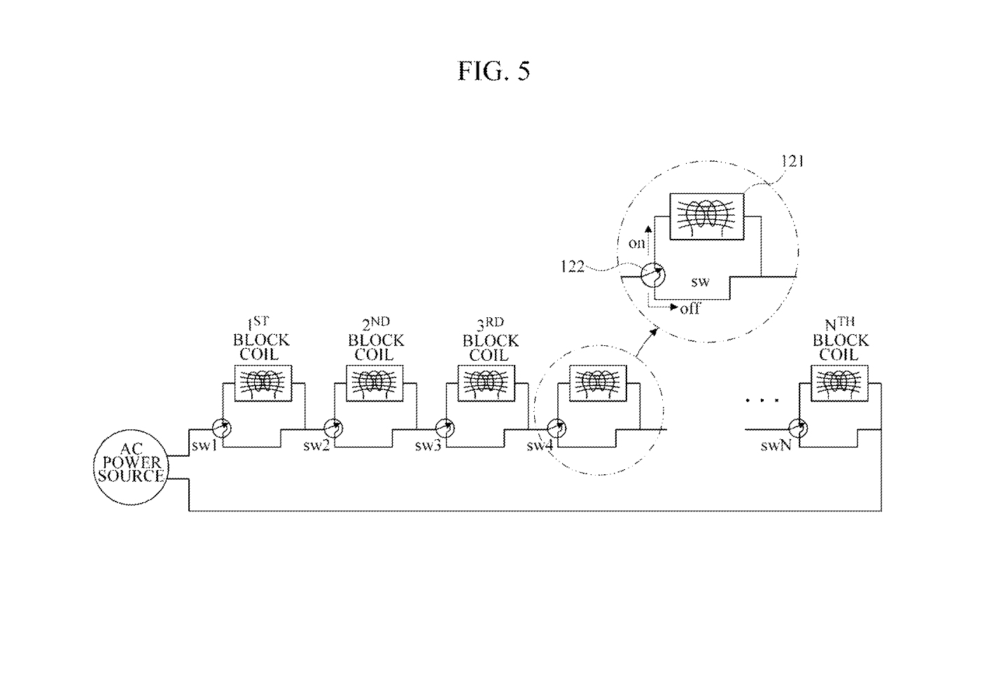

FIG. 5 is a diagram illustrating an example of a switching structure for the block coils 121, according to an exemplary embodiment of the present invention.

Referring to FIG. 5, the block coils 121 may be connected in series such that an AC power generated by an AC power source may be applied to each of the block coils 121. In this example, the block coils 121 may coincide with each other in terms of the direction of the flow of a current therein, and an AC current that flows in the block coils 121, respectively, may be synchronized. If the block coils 121 are connected in parallel, an AC current may be applied to each of the block coils 121 by different AC power. In this parallel connection case, a phase difference between ACs that flow in the block coils 121, respectively, may occur due to the difference between the driving times of the different AC power sources, and thus, the magnetic flux between each pair of adjacent block coils 121 may be offset or attenuated. To address this problem, one or more switches 122 may be installed such that the serial connection between the block coils 121 may be maintained. As shown in FIG. 5, each switch may control connection of each block coil to the series of block coils 121.

When a switch 122 is switched on, an induced current may flow in a current block coil 121 to which the switch 122 is connected. When the switch 122 of the current block coil 121 is switched off, the induced current may flow along a line between the previous block coil 121 and the next block coil 121 that bypasses the current block coil 121. For example, if the is switch 122 for switching on or off the fourth block coil 121 is switched off, a bypass line between the third block coil 121 and the fifth block coil 121 bypasses the fourth block coil 121 by short-circuiting the fourth block coil 121. When the switch 122 of the fourth block coil 121 is switched off, the one end of the fourth block coil 121 is connected to the fifth block coil 121 while the other end of the fourth block coil 121 is disconnected by the switch 122 of the fourth block coil 121. When the switch 122 of the fourth block coil 121 is switched on, the fourth block coil 121 may be connected to the circuit by the switch 122 of the fourth block coil 121 while disconnecting one end of the short-circuit line between the third block coil and the fifth block coil. Thus, when the switch 122 of the fourth block coil 121 is switched on, a current flow that flows into the fourth block coil 121 may flow into the subsequent block coils 121 due to the switch 122 of the fourth block coil 121. In this manner, the block coils 121 may be connected in series such that a current may seamlessly flow from one block coil 121 to another block coil 121, and a current may be supplied to selected block coils by controlling the corresponding switches.

Valid block coils and a method of detecting the valid block coils will hereinafter be described. The detection of valid block coils will be described in further detail with reference to FIG. 6A and FIG. 6B.

FIG. 6A is a diagram illustrating an example of a chargeable terminal placed over a non-contact charging device according to an exemplary embodiment of the present invention, and FIG. 6B is a graph illustrating an example of voltages induced in the chargeable terminal illustrated in FIG. 6A according to an exemplary embodiment of the present invention.

Referring to FIG. 6A, the sixth, seventh, tenth, eleventh, fourteenth, and fifteenth block coils of the primary coil 120 are matched with a secondary coil 620 of a chargeable terminal 610. The sixth, seventh, tenth, eleventh, fourteenth, and fifteenth block coils that correspond to the secondary coil 620 are determined as valid block coils. For example, to detect valid block coils from the primary coil 120, the first control unit 110 may control the block coil switching unit 112 to sequentially switch on the switches 122 and to sequentially supply a current to the block coils 121. That is, a switch SW1 of the first block coil is switched on, a switch SW2 of the second block coil is switched on with the switch SW1 on, and a switch SW3 of the third block coil is switched on with the switches SW1 and SW2 on. This switching process may be sequentially performed according to the index numbers of the block coils 121 until all the switches, including a switch of an N-th block coil, are switched on. In this example, in response to the switches of the first to N-th block coils being sequentially switched on, an induced voltage and current may be generated in the secondary coil 620 of the chargeable terminal 610, as illustrated in FIG. 6B. Referring to FIG. 6B, an induced voltage generated in a matching block coil of the secondary coil 620 significantly differs from an induced voltage generated in a previous block coil to the matching block coil. Accordingly, block coils that produce significant induced voltage differences with their respective neighboring block coils, i.e., the sixth, seventh, tenth, eleventh, fourteenth, and fifteenth block coils, may be detected as valid block coils.

In another example, the first control unit 110 may sequentially turn on the block coils 121 of the primary coil 120, but not cumulatively. That is, the switch SW1 of the first block coil may be switched on for a predetermined amount of time and switched off, the switch SW2 of the second block coil is switched on for the predetermined amount of time and switched off, and the switch SW3 of the third block coil is switched on for the predetermined amount of time and switched off. This switching process may be sequentially performed until the N-th block coil of the primary coil 120 is turned on. In this example, a default induced voltage of, for example, 0 V, may be applied to each block coil that does not match the secondary coil 620, and a significant induced voltage difference (for example, greater than a reference voltage Ref Volt) may be detected from each block coil that matches the secondary coil 620. Each block coil that produces such a significant induced voltage difference may be detected as a valid block coil.

FIG. 7 is a block diagram illustrating an example of the induced voltage detection unit of a chargeable terminal according to an exemplary embodiment of the present invention.

Referring to FIG. 7, an induced voltage detection unit, such as the induced voltage detection unit 204 of FIG. 3, may include a first register 702, comparison registers 704 and 706 (i.e., Sum(k) and Sum(k−1)), a counter 708, a calculator 710, a DC-to-AC converter 712, a comparator 714, and a second register 716.

The first register 702 may sequentially store one or more induced voltages output by the AC-to-DC conversion unit 202. The first register 702 may include a plurality of internal registers Sum(0) through Sum(N). The number of internal registers in the first register 702 may be determined based on the number of block coils of the primary coil 120. For example, if there are N block coils, (N+1) internal registers may be provided in the first register 702. Each of the internal registers Sum(1) through Sum(N) may store an induced voltage generated in the secondary coil 620 in response to the application of an AC power to each of the first through N-th block coils of the primary coil 120.

In the internal register Sum(0), a default voltage of, for example, 0 V, which is a voltage level when no current flows in the block coils 121 of the primary coil 120 and no induced voltage is generated in the secondary coil 620, may be stored. In the internal register Sum(1), an induced voltage generated by the first block coil 121, i.e., an induced voltage generated in response to the application of a current to the first block coil 121, may be stored. In is the internal register Sum(2), an induced voltage generated in the secondary coil 620 by the first and second block coils 121 may be stored. In the internal register Sum(3), an induced voltage generated in the secondary coil 620 by the first, second, and third block coils 121 may be stored. Similarly, in the internal register Sum(N), an induced voltage generated in the secondary coil 620 by the first through N-th block coils 121 may be stored.

The induced voltages stored in the internal registers Sum(0) through Sum(N) may be sequentially input to the comparison registers 704 and 706.

The counter 708 may count the induced voltages input to the comparison registers 704 and 706. For example, in response to the induced voltage stored in the internal register Sum(1) being input to the comparison register 704, the count value of the counter 708 may be set to 1. In response to the induced voltage value stored in the internal register Sum(2) being input to the comparison register 704, the count value of the counter 708 may be set to 2. The count value may be associated with an index of a block coil of the primary coil 120.

More specifically, the induced voltage stored in the internal registers Sum(0) through Sum(N) may be loaded in the comparison registers 704 and 706, which are the registers of the calculator 710. For example, in response to the induced voltages stored in the internal registers Sum(1) and Sum(0) being input to the calculator 710 via the comparison registers 704 and 706, respectively, the count value of the counter 708 is increased by one. In response to the induced voltages stored in the internal registers Sum(2) and Sum(1) being input to the calculator 710 via the comparison registers 704 and 706, respectively, the count value of the counter 708 is increased again by one.

In another example, by using the count value of the counter 708, induced voltages to be loaded in the comparison registers 704 and 706, which are the registers of the calculator 710, may be selected from among the induced voltages stored in the internal registers Sum(0) through Sum(N). An induced voltage stored in an internal register corresponding to a count value of the counter 708 may be input to the comparison register 704. If the counter 708 is set to an initial count value of 1, the induced voltage stored in the internal register Sum(1) may be loaded in the comparison register 704, and the induced voltage stored in the internal register Sum(0) may be loaded in the comparison register 706. Thereafter, the count value of the counter 708 may be increased by one (i.e., k=2). Then, the induced voltage stored in the internal register Sum(2) may be loaded in the comparison register 704, and the induced voltage stored in the internal register Sum(1) may be loaded in the comparison register 706. The induced voltage loading process may be repeatedly performed until the count value of the counter 708 reaches N.

The comparison registers 704 and 706 may not be provided in the induced voltage detection unit 204. In this example, the induced voltages stored in the internal registers Sum(0) through Sum(N) may be directly loaded in the calculator 710.

The calculator 710 may calculate a differential voltage between the induced voltages loaded in the comparison registers 704 and 706, i.e., Sum(k)−Sum(k−1), and may output the calculated differential voltage.

The DC-to-AC converter 712 converts the calculated differential voltage output by the calculator 710 into an analog signal, and outputs the analog signal.

The comparator 714 detects any induced voltage discrepancy by comparing the analog signal output from the DC-to-AC converter 712 with the reference voltage Ref Volt. The reference voltage Ref Volt may be used in case the boundaries of the secondary coil 620 do not exactly coincide with the boundaries between the block coils 121. Unlike the example illustrated in FIG. 6A, the boundaries of the secondary coil 620 may have different shapes in comparison with the boundaries of the block coils of the primary coil. The reference voltage Ref Volt may be used to properly detect valid block coils even in a case when some of the matching block coils of the primary coil match the secondary coil 620 only partially. The reference voltage Ref Volt may be set based on an induced voltage difference that may be produced by a partially matching block coil of the secondary coil 620, for example, a 1/n-matching block coil of the secondary coil 620, which is a block coil matching the secondary coil 620 only by 1/n of its area. For example, if the reference voltage Ref Volt is set to half the induced voltage difference that may be produced by a full-matching block coil of the secondary coil 620, any block coil that matches the secondary coil 620 by more than half the area thereof may be detected as a valid block coil.

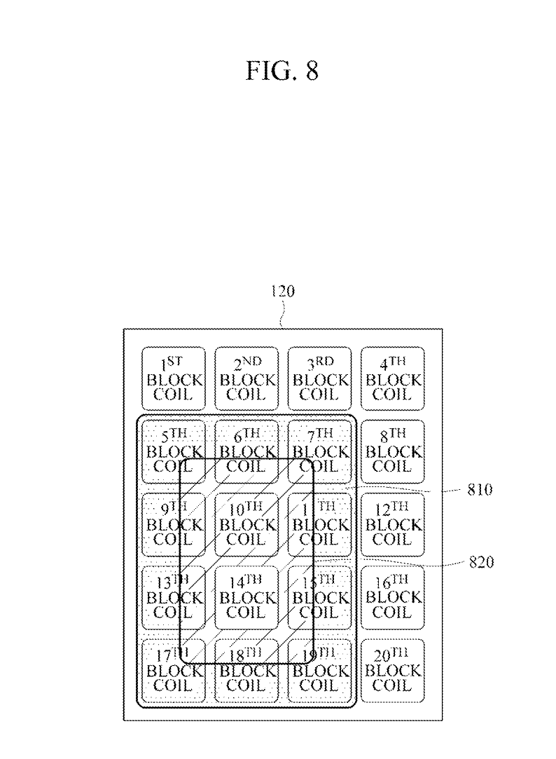

FIG. 8 is a diagram illustrating an example of a chargeable terminal placed over a non-contact charging device according to an exemplary embodiment of the present invention.

Referring to FIG. 8, if the reference voltage Ref Volt is set to an induced voltage difference that may be produced by a half-matching block coil in association with a secondary coil 820, the sixth, ninth, eleventh, thirteenth, fifteenth, and eighteenth block coils of the primary coil 120 may be determined as valid block coils.

Referring back to FIG. 7, if the result of the comparison performed by the comparator 714 indicates that an induced voltage difference has been detected, a valid block coil indicator signal may be output to indicate that a block coil that has produced the induced voltage difference, i.e., a k-th block coil, is a valid block coil.

The second register 716 stores a count value of the counter 708 at the time of the output of the valid block coil indicator signal, i.e., k. The count value stored in the second register 716 may indicate a valid block coil index.

An induced voltage discrepancy may occur due to a voltage variation from the is surroundings of the non-charging device 100. In this case, a non-matching block coil may be erroneously detected as a valid block coil. To address this problem, the reference voltage Ref Volt may be compared with any detected induced voltage difference. Accordingly, it is possible to prevent a non-matching block coil from being erroneously detected as a valid block coil.

As described above, the first control unit 110 may sequentially turn on the first through N-th block coils of the primary coil 120, but not cumulatively. In this non-cumulative example, the calculator 710 may detect block coils each producing an induced voltage difference greater than the reference voltage Ref Volt as valid block coils by performing computation on the default induced voltage stored in the internal register Sum(0) and each of the induced voltages stored in the other internal registers Sum(1) through Sum(N), instead of performing computation on the induced voltages stored in each pair of adjacent internal registers in the first register 702.

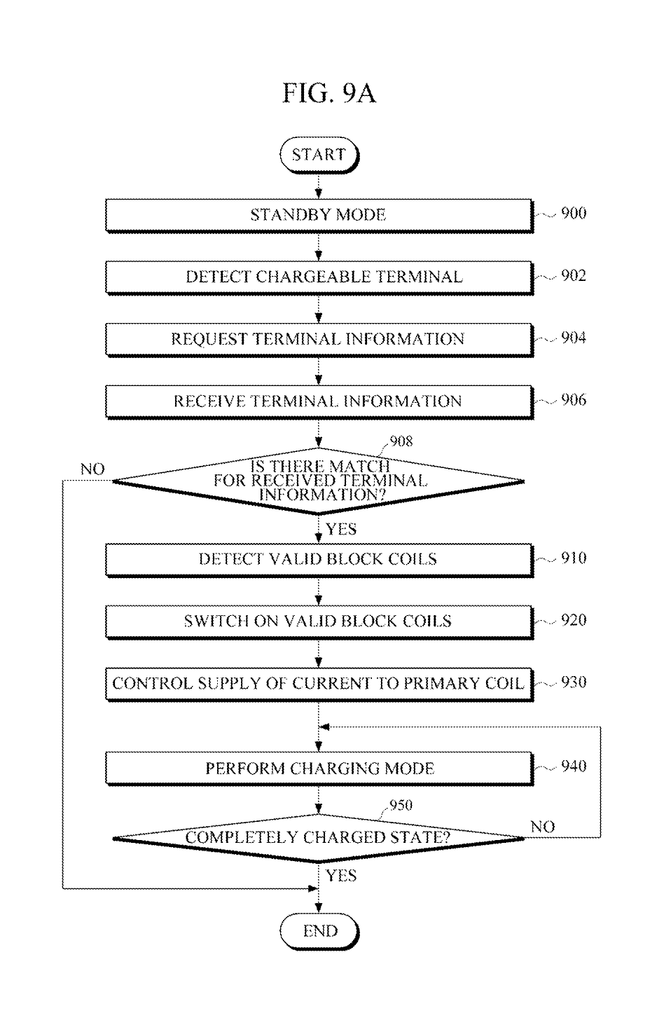

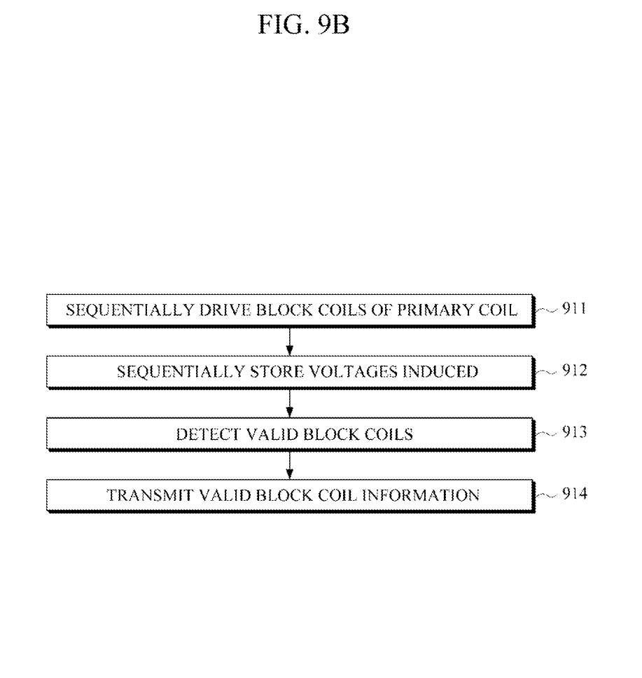

FIG. 9A is a flowchart illustrating a non-contact charging method according to an exemplary embodiment of the present invention, and FIG. 9B is a flowchart illustrating a method for detecting valid block coils according to an exemplary embodiment of the present invention.

Referring to FIG. 9A, in response to the application of AC power to the non-contact charging device 100, in operation 900, the non-contact charging device 100 enters a charging standby mode. The term “charging standby mode,” as used herein, indicates an operating mode in which the non-contact charging device 100 is ready to supply power to the chargeable terminal 200 in response to an arrangement of the chargeable terminal 200 in association with the non-contact charging device 100. For example, the chargeable terminal 200 may be placed in a cradle of the non-contact charging device 100 for the non-contact charging operation.

In response to the arrangement of the chargeable terminal 200 being placed in a charging location, e.g., the cradle, in operation 902, the first control unit 110 may detect the chargeable terminal 200 placed in the charging location. As described above, a sensor, such as a pressure sensor, may be installed in the charging location so that a contact between the charging location and the chargeable terminal 200 may be detected.

In response to the placement of the chargeable terminal 200 in a charging location, in operation 904, the first control unit 110 may transmit a request for terminal information of the chargeable terminal 200 to the second communication unit 212 via the first communication unit 116.

The second control unit 210 may transmit the terminal information of the chargeable terminal 200 to the first communication unit 116 in response to the receipt of the request transmitted from the first control unit 110.

In operation 906, the first control unit 110 may receive the terminal information of the chargeable terminal 200 via the first communication unit 116. In operation 908, the first control unit 110 may determine whether the received terminal information matches terminal information stored in the storage unit 108. If the received terminal information matches the terminal information stored in the storage unit 108, the chargeable terminal 200 is determined to be a target terminal to be charged. If the received terminal information does not match the terminal information stored in the storage unit 108, the charged terminal 200 is determined not to be the target terminal.

In response to the determination that the chargeable terminal 200 is the target terminal, the first control unit 110 may search for valid block coils from the primary coil 120 in operation 910.

Referring to FIG. 9B, in response to the detection of the chargeable terminal 200, the first control unit 110 may generate an induced current in the block coils 121, respectively, by controlling the block coil switching unit 112 to sequentially switch on the switches 122 connected to the block coils 121 in operation 911. The first control unit 110 may transmit a request for detection of valid block coils to the chargeable terminal 220 via the first communication unit 116.

In response to the receipt of the request transmitted from the first control unit 110, the second control unit 210 may generate a request for detection of an induced current generated in the secondary coil 220 to the induced voltage detection unit 204. In operation 912, the induced voltage detection unit 204 may sequentially store one or more induced voltages detected from the secondary coil 220 in the first register 702. In operation 913, the induced voltage detection unit 204 may detect valid block coils from the primary coil 120 based on the induced voltages stored in the first register 702.

In operation 914, the second control unit 210 may receive valid block coil information, which is information on the valid block coils detected by the induced voltage detection unit 204, and transmit the valid block coil information to the first communication unit 116 via the second communication unit 221.

For example, in operation 911, the time of switching on each of the switches 122 of the block coils 121 may be synchronized between the non-contact charging device 100 and the chargeable terminal 200. In response to the switching operation of the switch of a valid block coil, an induced voltage difference may occur in the secondary coil 220, and thus, the chargeable terminal 200 may recognize that the switch of the valid block coil is turned on. Further, since no induced voltage difference occurs in the secondary coil 220 in response to the switching is operation of the switch of a non-valid block coil, the chargeable terminal 200 may not be able to determine whether the switch of the non-valid block coil is turned on or off. Accordingly, the first control unit 110 may transmit information relating to a switch that is switched on, i.e., information relating to a block coil that is turned on by the switch. The second control unit 210 may identify the turned-on block coil with the information relating to a switch received from the second communication unit 212, and may determine whether the identified block coil is a valid block coil with the detection results of the induced voltage detection unit 204. Further, the switches 122 may be switched on at regular intervals of time, and the interval of switching operation may be shared in advance between the non-contact charging device 100 and the chargeable terminal 200.

Referring back to FIG. 9A, in operation 920, the first control unit 110 switches on valid block coils, detected in operation 910, with reference to the valid block coil information received by the first communication unit 116. In this manner, it is possible to achieve increased power transmission efficiency regardless of the size and location of the secondary coil.

In response to the detection of the valid block coils, the first control unit 110 may control the magnitude of an AC current that is supplied to the primary coil 120 in operation 930. To provide a charging current to the battery 216 of the chargeable terminal 200, an induced voltage of the secondary coil 220 may need to fall within an input voltage range of a DC-to-DC conversion unit. To generate the induced voltage having the magnitude within the voltage range, the magnetic flux in the primary coil 212 may be controlled. Once the location and size of the primary coil 120 are determined, an AC current that flows in the primary coil 120 may be increased to increase the induced voltage of the secondary coil 220. However, if the AC current in the primary coil 120 increases greater than a risk limit, too much heat may be generated in the primary coil 120 and risks of damage may increase.

To address this problem, in response to the detection of abnormal states or conditions, such as an abnormally high temperature, an excessive current, an excessive voltage, etc., of the non-contact charging device 100 or the chargeable terminal 200, the charging of the chargeable terminal 200 may be terminated by cutting off the supply of an AC current to the primary coil 120.

A DC induced voltage in the secondary coil 220 may be fall between the minimum operating input voltage and the maximum operating input voltage of the DC-to-DC conversion unit 206. Since an induced voltage is generated by a variation in the magnetic flux of the primary coil 120 and the magnetic flux variation corresponds to a current that flows in the primary coil 120, the current that flows in the primary coil 120 may be controlled with reference to an AC input to the primary coil 120 at the time of the generation of an induced voltage. In this manner, the operation of the non-contact charging system may be stabilized.

In operation 940, the chargeable terminal 200 may charge the battery 216 of the chargeable terminal 200 with a generated charging current. While operating in a charging mode, the first control unit 110 may determine whether the battery 216 is fully charged. If the battery 216 is fully charged, the charging of the battery 216 may be terminated by cutting off the supply of an AC current to the primary coil 120. If the battery 216 is not fully charged, the chargeable terminal 200 may repeat the operation 940. If the non-contact charging device 100 or the chargeable terminal 200 is in an abnormal state associated with, for example, an abnormally high temperature, an excessive current, an excessive voltage, etc., the charging of the battery 216 may be terminated regardless of whether the battery 216 is fully charged, thereby, the non-contact charging system may be protected.

A portion of operations, for example, operations 902, 904, 906, and 908, may be optional. In this example, the non-contact charging method begins with operation 910 in response to a charge request from a user, and the first control unit 110 of the non-contact charging device 100 may not transmit a valid block coil information request signal to the second communication unit 212 of the chargeable terminal 200. The valid block coil information request signal may be received from the user, and the non-contact charging device 100 and the chargeable terminal 200 may perform the non-contact charging method beginning from operation 910.

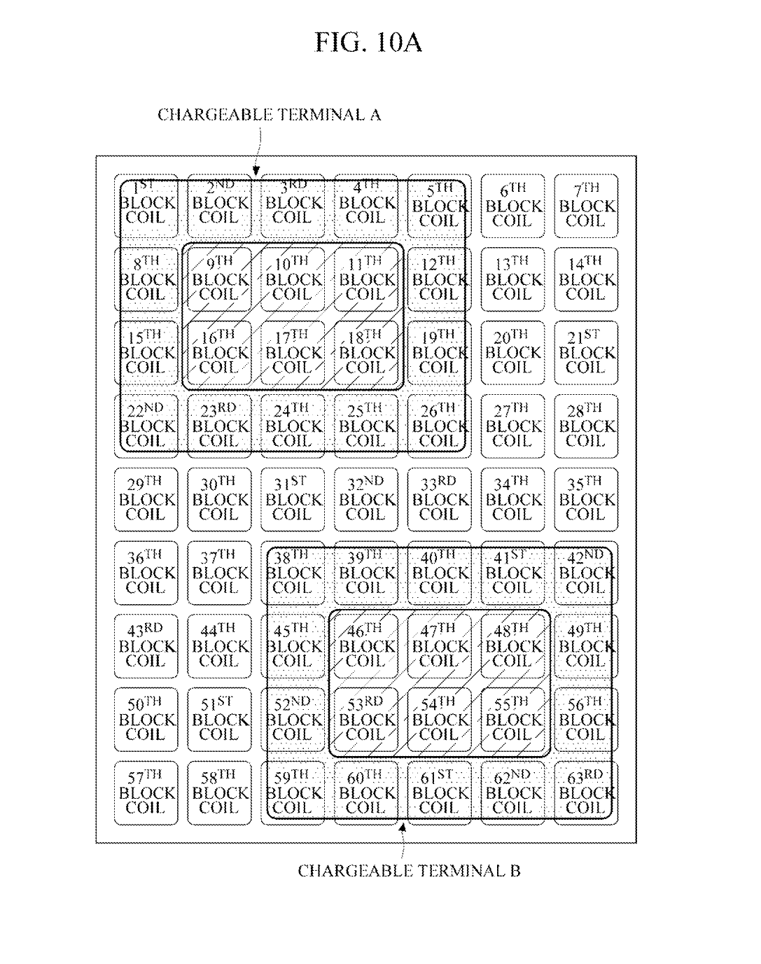

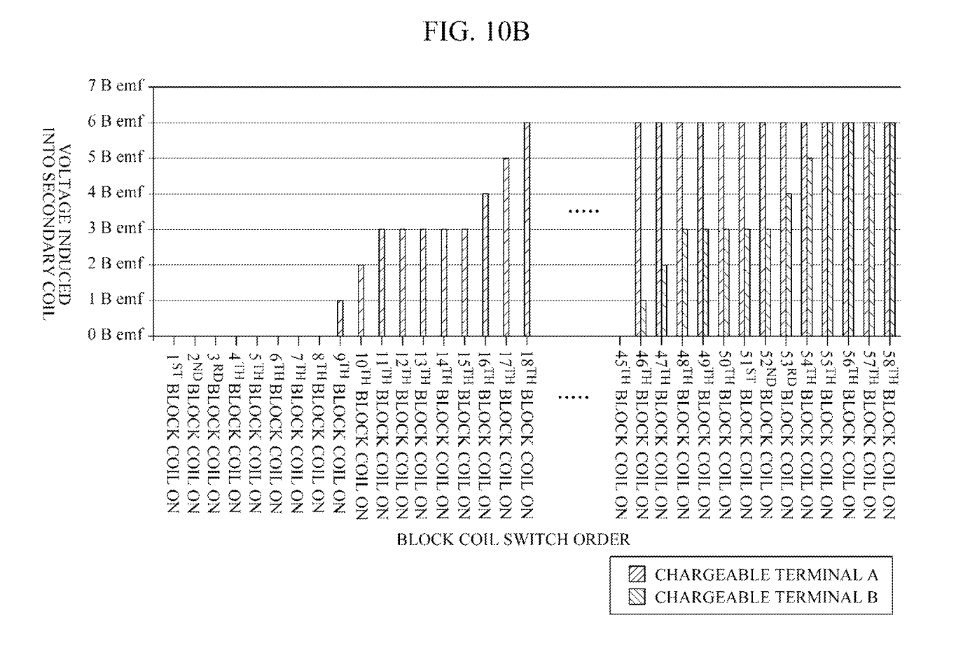

FIG. 10A is a diagram illustrating an example of multiple chargeable terminals placed over a non-contact charging device according to an exemplary embodiment of the present invention, and FIG. 10B is a graph illustrating an example of voltages induced in the multiple chargeable terminals illustrated in FIG. 10A according to an exemplary embodiment of the present invention.

Referring to FIG. 10A, two or more charged terminals may be placed over the non-contact charging device 100. A secondary coil of chargeable terminal A matches ninth, tenth, eleventh, sixteenth, seventeenth, and eighteenth block coils of the primary coil 120 of the non-contact charging device 100. That is, the ninth, tenth, eleventh, sixteenth, seventeenth, and eighteenth block coils are valid block coils for chargeable terminal A. A secondary coil of chargeable terminal B matches forty sixth, forty seventh, forty eighth, fifty third, fifty fourth, and fifty fifth block coils of the primary coil 120 of the non-contact charging device 100. That is, the forty sixth, forty seventh, forty eighth, fifty third, fifty fourth, and fifty fifth block coils are valid block coils for chargeable terminal B.

To detect valid block coils from the primary coil 120 of the non-contact charging is device 100, the first control unit 110 sequentially switches on the block coils 121 of the primary coil 120 by controlling the block coil switching unit 112. For example, the first block coil is switched on, the second block coil is switched on while the first block coil is switched on, and the third block coil is switched on while the first and second block coils are switched on. If the block coils 121 of the primary coil 120 are sequentially switched on, induced voltages may be generated in the secondary coils of chargeable terminals A and B, respectively, as illustrated in FIG. 10B.

Referring to FIG. 10B, induced voltage differences are detected from the switching operations of the ninth, tenth, eleventh, sixteenth, seventeenth, and eighteenth block coils of the primary coil 120, i.e., the valid block coils for the chargeable terminal A, and are also detected from the switching operations of the forty sixth, forty seventh, forty eighth, fifty third, fifty fourth, and fifty fifth block coils of the primary coil 120, i.e., the valid block coils for the chargeable terminal B.

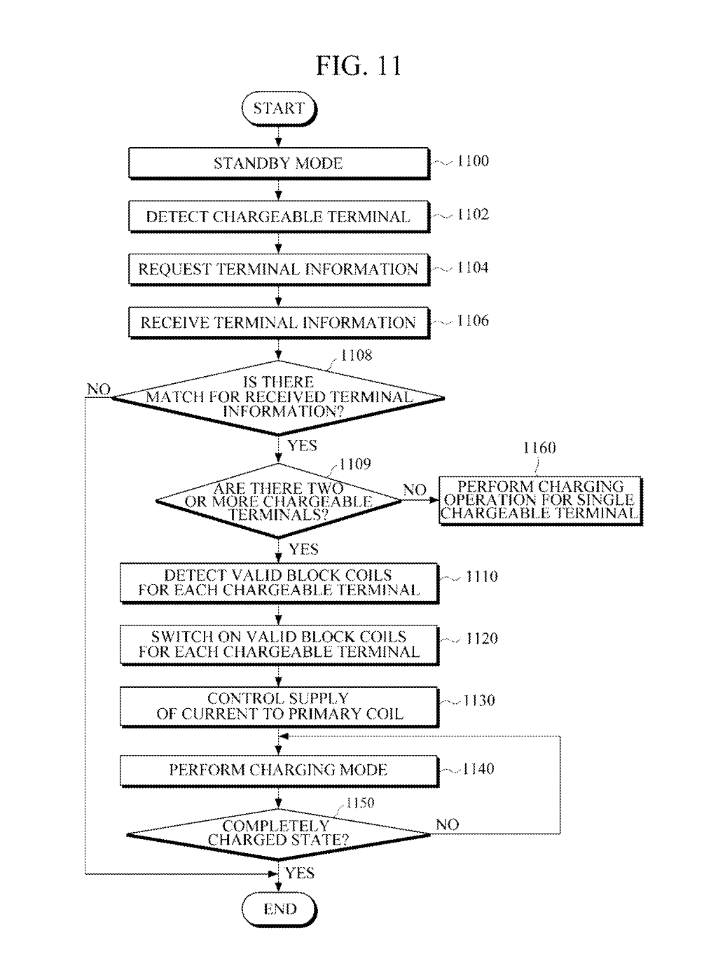

FIG. 11 is a flowchart illustrating a non-contact charging method using block coils according to an exemplary embodiment of the present invention.

Operations 1100, 1102, 1104, 1106, and 1108 of FIG. 11 are the same as operations 900, 902, 904, 906, and 908 of FIG. 9A, respectively, and thus, detailed descriptions thereof will be omitted. In the example illustrated in FIG. 11, multiple chargeable terminals may be detected as target terminals to be charged, and operations 1100, 1102, 1104, 1106, and 1108 may be performed by driving the multiple chargeable terminals in connection with each other.

In operation 1109, the first control unit 110 of the non-contact charging device 100 may determine whether there are multiple target terminals to be charged. If one target terminal to be charged exists, a charging operation for a single target terminal may be performed, i.e., operations 910, 920, 930, 940, and 950 of FIG. 9A may be performed.

If multiple target terminals to be charged exist, valid block coils for each of the target terminals may be searched for from the primary coil 120 in operation 1110. The first control unit 110 of the non-contact charging device 100 may transmit a request for detection of valid block coils to each of the target terminals via the first communication unit 114, and receive valid block coil information from each of the target terminals. Operation 1110 may be performed in the same manner described above with reference to FIG. 9B.

In operation 1120, the first control unit 110 may switch off each of the non-valid block coils, and maintain switched-on states of valid block coils detected in operation 1110, with reference to valid block coil information received from each of the target terminals via the first communication unit 116. For example, in operation 1120, two or more non-consecutive valid block coils may be switched on, as illustrated in FIG. 10A.

In operation 1130, in response to the detection of the valid block coils from the primary coil 120, the first control unit 110 may control the magnitude of an AC current supplied to the primary coil 120. The magnitude of an AC current supplied to the primary coil 120 may be controlled based on different specification of target terminals. For example, the target terminals may be different from each other in terms of specification and may be different from each other in terms of charging capacity and charging current.

For example, the magnitude of an AC supplied to the primary coil 120 may be controlled, based on the minimum charging current among the charging currents of the target terminals such that the same AC current may flow into the target terminals, respectively.

In another example, the magnitude of an AC current supplied to the primary coil 120 may be controlled such that different charging currents for each of the target terminals may is flow into corresponding groups of valid block coils, respectively.

As described above, in response to the control of the current of the primary coil 120, operations 1140 and 1150 may be performed. Operations 1140 and 1150 may be performed in the same manner as described above with reference to the operations 940 and 950 in FIG. 9A.

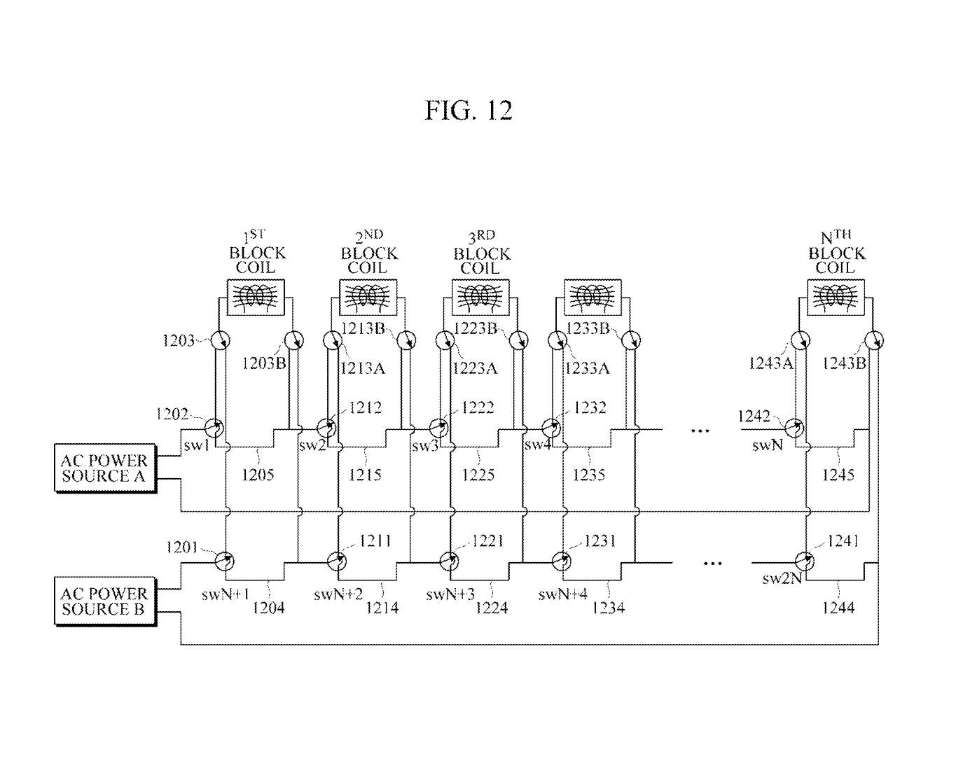

FIG. 12 is a diagram illustrating an example of a switching structure for a plurality of block coils in a non-contact charging device according to an exemplary embodiment of the present invention.

Unlike the switching structure illustrated in FIG. 5, the switching structure illustrated in FIG. 12 includes multiple AC power sources, e.g., two AC power sources, which are connected in series such that AC currents may flow into each of the block coils. Referring to FIG. 12, the switching circuit includes switches 1201, 1211, 1221, 1231, and 1241, which switch on or off the block coils such that a current from AC power source B may flow into each of the block coils, switches 1202, 1212, 1222, 1232, and 1242, which switch on or off the block coils such that a current from AC power source A may flow into each of the block coils, and switches 1203A, 1203B, 1213A, 1213B, 1223A, 1223B, 1233A, 1233B, 1243A, and 1243B, which select an AC current from one of AC power sources A and B to flow into each of the block coils. Based on multiple AC power sources, two or more chargeable terminals having different charging currents may be charged by charging currents from different AC power sources. For example, a current from AC power source A may be configured to flow into the valid block coils for a first chargeable terminal, and a current from AC power source B may be configured to flow into the valid block coils for a second chargeable terminal. If the switches 1201, 1211, 1221, 1231, and 1241 are switched on, the corresponding block coils are connected to the AC power source B, respectively. If the switches 1201, 1211, 1221, 1231, and 1241 are switched off, the corresponding block coils are disconnected from the AC power source B and circuits 1204, 1214, 1224, 1234, and 1244 are connected to the AC power source B, respectively. If the circuits 1204, 1214, 1224, 1234, and 1244 are connected, the current from the power source B bypasses the corresponding block coils via circuits 1204, 1214, 1224, 1234, and 1244, respectively. If the switches 1202, 1212, 1222, 1232, and 1242 are switched on, the corresponding block coils are connected to the AC power source A, respectively. If the switches 1202, 1212, 1222, 1232, and 1242 are switched off, the corresponding block coils are disconnected from the AC power source A and circuits 1205, 1215, 1225, 1235, and 1245 are connected to the AC power source A, respectively. If the circuits 1205, 1215, 1225, 1235, and 1245 are connected, the current from the power source A bypasses the corresponding block coils via circuits 1205, 1215, 1225, 1235, and 1245, respectively. As described above with respect to FIG. 5, by switching on/off the switches 1201, 1211, 1221, 1231, and 1241 and the switches 1202, 1212, 1222, 1232, and 1242, a current flow into a desired block coil may be controlled.

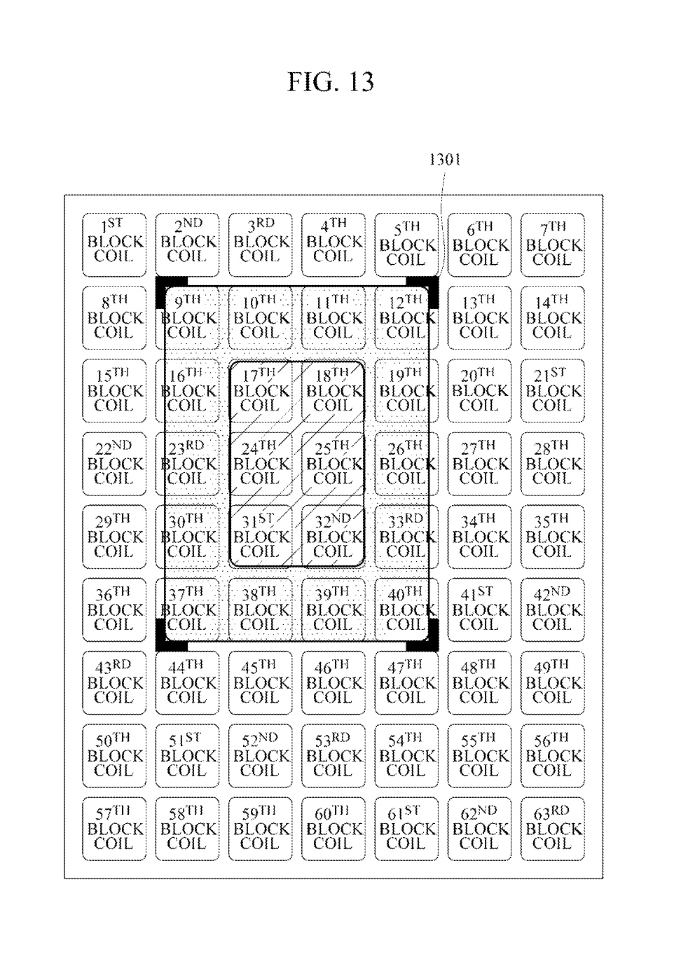

FIG. 13 is a diagram illustrating an example of a switching structure for a plurality of block coils in a non-contact charging device according to an exemplary embodiment of the present invention.

Referring to FIG. 13, the cradle of the non-contact charging device 100 may include a location fixer 1301. The first control unit 110 may store information relating to one or more block coils corresponding to the location fixer 1301 in the storage unit 108, and switch on only the block coils corresponding to the location fixer 1301, thereby reducing the delay in the detection of valid block coils. As shown in FIG. 13, the seventeenth, eighteenth, twenty fourth, twenty fifth, thirty first, and thirty second block coils may be determined as valid block coils based on the locations of location fixers 1301, for example.

The non-contact charging device, the non-contact charging system, and the non-contact charging method according to aspects of the present invention may perform a charging operation while offering increased power transmission efficiency for various chargeable terminals having different types of batteries.

As illustrated in FIG. 3 to FIG. 13, the induced voltage detection unit 204 is included in the chargeable terminal 200, for example. The induced voltage detection unit 204 may be included in the non-contact charging device 100. Since the non-contact charging device 100 may detect valid block coils, the non-contact charging device 100 may not transmit valid block coil information to the chargeable terminal 200. Instead, the chargeable terminal 200 may transmit information indicating whether any induced voltage differences occur in the secondary coil 220 in response to the switching on of each of the block coils 121 and the degrees of the detected induced voltage differences to the non-contact charging device 100, and the non-contact charging device 100 may detect valid block coils based on the information transmitted by the chargeable terminal 200.

According to exemplary embodiments, increased charging efficiency may be attained by dividing a primary coil of a non-contact charging device into a plurality of block coils and adjusting the block coils to be properly aligned with the secondary coils of various chargeable terminals equipped with different batteries. Also, the manufacturing cost of a non-contact charging device may be reduced by using switches between the block coils to align the block coils, instead of using expensive sensors and driving motors.

Further, increased charging efficiency may be achieved by detecting matching block coils for the secondary coil from the primary coil based on any induced voltage variations detected from the secondary coil.

Further, valid block coils for the secondary coil may be detected among block coils of a primary coil. Since the size and location of the secondary coil may vary from one terminal to another terminal, the primary coil may be driven without proper matching with the secondary coil, if the primary coil is aligned simply based on the size of a chargeable terminal. According to aspects of the present invention, this type of driving error may be prevented or decreased.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A wireless charging device, comprising:
a first block coil to transfer wireless power;
a first power source to provide the first block coil with a current for generating a first wireless power;
a first switch to connect the first power source with the first block coil; and
a controller to determine whether the first block coil is a valid block coil for a first chargeable terminal, and to control the first switch to connect the first power source with the first block coil if the first block coil is determined as a valid block coil for the first chargeable terminal.

2. The wireless charging device of claim 1, further comprising: a communication unit to receive information indicating whether the first block coil is a valid block coil from the first chargeable terminal.

3. The wireless charging device of claim 2, wherein the information indicating whether the first block coil is a valid block coil comprises induced voltage information.

4. The wireless charging device of claim 3, wherein the first block coil is determined as a valid block coil if an induced voltage value corresponding to the first block coil is greater than a reference voltage.

5. The wireless charging device of claim 2, wherein the induced voltage information comprises an induced voltage value associated with a block coil, and the controller comprises a valid block coil determining unit comprising:
a register to store a first induced voltage value associated with the first block coil, and to store a second induced voltage value associated with a second block coil of the wireless charging device;
a calculator to calculate a difference between the first induced voltage value and the second induced voltage value, the first and second induced voltage values being retrieved from the register; and
a comparator to compare the difference between the first induced voltage value and the second induced voltage value with a reference voltage.

6. The wireless charging device of claim 5, wherein the valid block coil determining unit determines the second block coil as a valid block coil if the difference between the first induced voltage value and the second induced voltage value is greater than the reference voltage.

7. The wireless charging device of claim 1, further comprising:
a second block coil to transfer wireless power; and
a second switch to connect the first power source with the second block coil,
wherein the first power source provides the second block coil with a current for generating a second wireless power, and
the controller determines whether the second block coil is a valid block coil for the first chargeable terminal, and controls the second switch to connect the first power source with the second block coil if the second block coil is determined as a valid block coil for the first chargeable terminal.

8. The wireless charging device of claim 7, wherein the first block coil and the second block coil are configured to be connected in a series connection when the first switch and the second switch are switched on.

9. The wireless charging device of claim 1, further comprising: a second power source to provide the first block coil with a current for generating a third wireless power.

10. The wireless charging device of claim 9, further comprising:
a third switch to connect the second power source with the first block coil; and
a fourth switch to connect the second power source with the second block coil,
wherein the controller determines whether the first and second block coils are valid block coils for a second chargeable terminal, controls the third switch to connect the second power source with the first block coil if the first block coil is determined as a valid block coil for the second chargeable terminal, and controls the fourth switch to connect the second power source with the second block coil if the second block coil is determined as a valid block coil for the second chargeable terminal.

11. The wireless charging device of claim 10, wherein the controller determines the first block coil as a valid block coil for the first chargeable terminal if wireless power transfer from the first block coil to a receiving coil of the first chargeable terminal is confirmed, and determines the first block coil as a valid block coil for the second chargeable terminal if wireless power transfer from the first block coil to a receiving coil of the second chargeable terminal is confirmed.

12. The wireless charging device of claim 9, further comprising: at least one switch to switch a connection of the first block coil to the first power source or to the second power source.

13. The wireless charging device of claim 1, further comprising: a location fixer to fix a location of the first chargeable terminal.

14. A method for operating a wireless charging device, comprising:
detecting a chargeable terminal;
detecting a valid block coil according to information transmitted from the chargeable terminal;
switching on the valid block coil; and
controlling a current supply to the valid block coil.

15. The method of claim 14, wherein detecting of the valid block coil comprises:
driving block coils of a primary coil;
receiving induced voltage information from the chargeable terminal; and
detecting the valid block coil according to the induced voltage information.

16. The method of claim 15, wherein the block coils of the primary coil are driven sequentially.

17. The method of claim 15, further comprising:
determining whether an induced voltage value corresponding to a block coil of the primary block coil is greater than a reference voltage based on the induced voltage value retrieved from the induced voltage information; and
detecting the block coil as a valid block coil if the induced voltage value corresponding to the block coil is greater than the reference voltage.

18. A terminal, comprising:
a receiving coil configured to induce a current in response to receipt of wireless power;
an induced voltage detection unit to measure an induced voltage value generated by the induced current, and to generate induced voltage information; and
a communication unit to transmit the induced voltage information to a wireless charging device.

19. The terminal of claim 18, wherein the induced voltage detection unit comprises:
a register to store induced voltage values measured in association with block coils of the wireless charging device;
a calculator to calculate a difference between a first induced voltage value and a second induced voltage value, the first and second induced voltage values being retrieved from the register; and
a comparator to compare the difference between the first induced voltage value and the second induced voltage value with a reference voltage.

20. The terminal of claim 19, wherein the induced voltage detection unit comprises a counter to count a count value associated with an index of a block coil of the wireless charging device.

21. The terminal of claim 18, further comprising: a safety circuit to terminate a charging operation if the induced current or temperature of the terminal is greater than a safety value.

22. The terminal of claim 18, wherein the induced voltage detection unit detects a valid block coil of a wireless charging device based on the induced voltage information, and
the communication unit transmits information on the valid block coil to the wireless charging device.

23. A wireless charging device, comprising:
one or more block coils;
a power source to supply a current to a valid block coil for a chargeable terminal, the valid block coil being selected from among the one or more block coils; and
a controller to detect the valid block coil for the chargeable terminal based on an induced voltage value, and to control a current flow into the valid block coil.
